(19) United States
(12) Patent Application Publication
(10) Pub. No.: US 2002/0085874 A1
(43) Pub. Date: Jul. 4, 2002

(54) Composite holding device

(76) Inventors: Hidehei Kagevarna, Kawagoe-shi (JP); Tadashi Yamamoto, Kawagoe-shi (JP); Tadayoshi Ebinuma, Kawagoe-shi (JP); Sachio Arai, Kawagoe-shi (JP)

Correspondence Address: McGinn & Gibb, PLLC, 8321 Old Courthouse Road, Suite 200, Vienna, VA, 22182-3817, US

(21) Appl. No.: 10/026,467

(22) Filed: Dec. 27, 2001

(30) Foreign Application Priority Data
Dec. 28, 2000 (JP) 2000-401281
Jan. 12, 2001 (JP) 2001-5638
May 30, 2001 (JP) 2001-162133

(51) Int. Cl. B43K 27/00

(52) U.S. Cl. 401/30; 401/29

(57) ABSTRACT

A composite holding device, includes a casing for accommodating a plurality of holders for holding media to serve either different or similar purposes, a supporting section for supporting the holders to be movable in an axial direction in the casing, a feed mechanism, provided in the casing, for selectively advancing one of the plurality of holders, and a manipulating mechanism for operating the feed mechanism, to project the tip of one of the plurality of holders out of a fore end opening at the tip of the casing and make usable the tip of one of the plurality of holders. A supported section of each holder supported by the supporting section is rotatably supported in relation to the supporting section.

### BACKGROUND OF THE INVENTION

1. Field of the Invention

The present invention relates to a composite holding device housing a plurality of holders for holding media for writing-related use (e.g., a pencil lead, an ink, a stick glue, an eraser and a correctional fluid), cosmetic media (e.g., a lipstick, an eye pencil, an eyeliner and an eyebrow pencil) or data inputting media (e.g., a stylus tip) and selectively projecting one of the plurality of holders to make it available for use.

1. Description of the Related Art

Known composite holding devices include, for instance, one described in Japanese Patent Publication No. 55-38280. This conventional composite holding device has a sleeve case having a fore end opening, a guide fixed to the rear end opening of the sleeve case and having two guide grooves extending in the axial direction and opposite each other diametrically, a mechanical pencil element (holder) and a ballpoint element (holder), each having a slider guided by the matching guide groove, and a sleeve acting cam surrounding the guide so as to be rotatable to the guide within a certain angle range and to be capable of transitioning in the axial direction with respect to the guide. The cam has a cam slide face formed on its lower end face to engage with the slider so that the cam, when turning in one direction, causes the tip of one of the two holders to project out of the fore end opening of the sleeve case and, when turning in the other direction, causes this holder to recede and the tip of the other holder to project out of the fore end opening of the sleeve case.

However, at the eccentric position away from the axial center of the sleeve case, the mechanical pencil element or the ballpoint element (e.g., which are holders) is accommodated in the sleeve case, whereas the fore end opening of the sleeve case, which is the projecting position of the holder, is on the axial center of the sleeve case, resulting in a positional gap in the radial direction between these positions.

Consequently, in this conventional configuration, as a holder advances, the tip of the holder shifts toward the fore end opening of the sleeve case in contact with the inner circumferential face of the sleeve case while being forcibly deviated in the radial direction of the sleeve case. As a result, the tip of the holder may be caught by the inner circumferential face of the sleeve case and thereby prevented from projecting out of the fore end opening of the sleeve case. This leads to limited freedom in the choice of the material or the dimensions of the holders because the holders should be made of a flexible material, or some allowance should be given in the length of the holders in the axial direction to make them more bendable.

Furthermore, the above-mentioned conventional composite holding device only permits selective use of one of two holders, comprising a mechanical pencil element (holder) holding a pencil lead and a ballpoint element (holder) holding ink. Thus, its range of applicability is narrow because the number of media is limited to a mechanical pencil and a ballpoint pen having only one color.

### BRIEF SUMMARY OF THE INVENTION

In view of the foregoing and other problems, drawbacks, and disadvantages of the conventional methods and structures, an object of the present invention is to provide a composite holding device enabling a holder, among a plurality of accommodated holders, to be advanced and its tip to be smoothly projected out of the fore end opening of a casing, without being constrained by the material or dimensions of the holders, thereby increasing the freedom in the choice of the materials or the dimensions of the holders.

A second object of the present invention is to provide a composite holding device capable of holding a greater number of media than any existing composite holding device.

To achieve the objects stated above and others, according to a first aspect of the present invention, a composite holding device includes a casing for accommodating a plurality of holders for holding media to serve either different or similar purposes, a supporting section for supporting the holders to be movable in the axial direction in the casing, a feed mechanism, provided in the casing, for selectively advancing one of the plurality of holders, and a manipulating mechanism for working the feed mechanism. The feed mechanism is worked by operating the manipulating mechanism to project the tip of one of the plurality of holders out of the fore end opening at the tip of the casing. The supported section of each holder supported by the supporting section is rotatably supported in relation to the supporting section and allows the tip of one of the plurality of holders to be used.

As one of the plurality of holders is advanced by the working of the feed mechanism, its tip projects out of the fore end opening. Even if in this action there is a deviation between the position of the holder tip when the holder is accommodated in the casing and that of the holder tip when it is projected out of the fore end opening at the tip of the casing in the radial direction, the holder tip can project out of the fore end opening of the casing without causing the holder itself to be substantially bent or meet significant resistance as it abuts the inner circumferential face of the casing because the supported section of the holder rotates in relation to the is supporting section.

Therefore, since the holders need not be highly bendable, the material or length of the holders is not subjected to any major constraint, thereby resulting in an enhanced design freedom.

Further, formation of a spherical bearing between the supporting section and the supported section provided on each of the holders would enable the supported section to be rotatably supported by the supporting section. This spherical bearing may include a spherical part formed on either one of the supporting section and the supported section provided on a holder and a concave part formed on the other one of the supporting section and supported section provided on the holder to receive the spherical part.

The media can be selected out of a group of media including writing-related media including a pencil lead, an ink, a stick glue, an eraser and a correctional fluid, cosmetic media including a lipstick, an eye pencil, an eyeliner and an eyebrow pencil and data inputting media including a stylus tip. This composite holding device can further be built into the cap of a writing tool.

To further achieve the objects stated above and others, according to a second aspect of the invention, a composite holding device includes a holder body for holding a medium to serve a prescribed purpose and a cap for covering the holder body.

The cap preferably includes a casing for accommodating a plurality of holders, each for holding a medium to serve a purpose either different from or similar to that of the medium, a supporting section for supporting the holders to be movable in the axial direction in the casing, a feed mechanism, provided in the casing, for selectively advancing one of the plurality of holders, and a manipulating mechanism for working the feed mechanism, the feed mechanism being worked by operating the manipulating mechanism to project the tip of one of the plurality of holders out of the fore end opening at the tip of the casing and to allow the tip of one of the plurality of holders to be used.

Preferably, the holder body holds the medium, and a plurality of holders are housed in the casing of the cap, so that, by working the manipulating functions provided on the cap, any desired holder can be selectively projected out of the fore end opening at the tip of the casing to make it available for use. As a result, a greater number of media can be held to expand the range of applicability.

The casing preferably includes an external sleeve, an intermediate sleeve fitted inside the external sleeve with the assistance of an ancillary sleeve, and a nose rotatable in relation to the external sleeve and the intermediate sleeve, an internal thread is formed on an inner circumferential face of the intermediate sleeve and a slit is formed on the internally threaded part of the intermediate sleeve, and an external thread is formed on an outer circumferential face of the ancillary sleeve.

Preferably, the externally threaded part of the ancillary sleeve or the internally threaded part of the intermediate sleeve has a tapered shape, and the external thread of the ancillary sleeve inserted into the external sleeve and the intermediate sleeve engages the internal thread of the intermediate sleeve inserted into the external sleeve. The slit of the intermediate sleeve is expanded to press the internally threaded part against an inner circumferential face of the external sleeve to fix the intermediate sleeve to the external sleeve and thereby to fit the intermediate sleeve inside the external sleeve.

By a simple operation mainly including the threaded engagement of the intermediate sleeve with the ancillary sleeve, the intermediate sleeve can be fitted to the external sleeve with the assistance of the ancillary sleeve without adversely affecting the looks of the external sleeve. This manner of fitting is applicable even where the configuration forbids the rotation of the intermediate sleeve in relation to the external sleeve, threading is impossible on either the external sleeve or the intermediate sleeve, or either the intermediate sleeve or the external sleeve includes a non-adhesive material, resulting in an expanded range of applicability.

It is possible to form a projection to be pressed against the inner circumferential face of the external sleeve on the outer circumferential face of the internally threaded part of the intermediate sleeve. The projection can serve to enhance the binding force between the intermediate sleeve and the external sleeve. Further, an adhesive tape or elastic member can be formed between the outer Ad circumferential face of the internally threaded part of the intermediate sleeve and the inner circumferential face of the external sleeve, to further enhance the binding force is between the intermediate sleeve and the external sleeve.

Alternatively, the casing may include an external sleeve, an intermediate sleeve fitted inside the external sleeve with the assistance of an ancillary sleeve and an elastic ring, and a nose rotatable in relation to the external sleeve and the intermediate sleeve, an internal thread is formed on either one of the intermediate sleeve and the ancillary sleeve, and an external thread to engage with the internal thread is formed on the other one.

Preferably, the intermediate sleeve and the elastic ring adjacent to the intermediate sleeve in the axial direction, are inserted into the external sleeve, the ancillary sleeve is inserted into the external sleeve from the elastic ring side, one of a part of the ancillary sleeve and a part of the intermediate sleeve penetrates the elastic ring, and the threaded engagement of the external thread with the internal thread serves to combine the intermediate sleeve and the ancillary sleeve. The elastic ring is compressed in the axial direction between the ancillary sleeve and the intermediate sleeve to be pressed against an inner circumferential face of the external sleeve and thereby to be fixed to the external sleeve, thereby resulting in the fitting of the intermediate sleeve inside the external sleeve.

Where the intermediate sleeve is to be fitted to the external sleeve with the assistance of the ancillary sleeve and the elastic ring, as the elastic ring elastically contacts the ancillary sleeve and/or the intermediate sleeve to forbid the ancillary sleeve and the intermediate sleeve from rotating in relation to each other, the threaded engagement between the ancillary sleeve and the intermediate sleeve is prevented from loosening, thereby resulting in a secure fitting of the intermediate sleeve to the external sleeve.

On the ancillary sleeve, a step face may be formed to come into contact with the elastic ring, and the step face may be inclined in relation to the direction of the external diameter. In this case, the elastic ring is progressively pressed in the direction of the external diameter (i.e., against the inner circumferential face) of the external sleeve as the ancillary sleeve approaches the elastic ring.

Alternatively, the casing may include an external sleeve, an intermediate sleeve fitted inside the external sleeve with the assistance of an ancillary sleeve and a C-ring, and a nose rotatable in relation to the external sleeve and the intermediate sleeve, an annular concave part is formed on an inner circumferential face of the external sleeve, and the C-ring is fitted into the annular concave part to project more in the direction of the internal diameter than the inner circumferential face of the external sleeve, an internal thread is formed on either one of the intermediate sleeve and the ancillary sleeve, and an external thread to engage the internal thread is formed on the other one. A part of the intermediate sleeve may be inserted into the external sleeve from one end of the external sleeve, and the other part of the intermediate sleeve not inserted into the external sleeve is brought into contact with the one end of the external sleeve. Preferably, the ancillary sleeve is inserted into the external sleeve from the other end of the external sleeve, one of a part of the ancillary sleeve and a part of the intermediate sleeve penetrates the C-ring, the threaded engagement of the external thread and internal thread with each other serves to combine the intermediate sleeve and the ancillary sleeve, and the ancillary sleeve comes into contact with the part of the C-ring projecting more than the inner circumferential face of the external sleeve from the other end side of the external sleeve, thereby resulting in the fitting of the intermediate sleeve inside the external sleeve.

Where the intermediate sleeve is to be fitted to the external sleeve with the assistance of the ancillary sleeve and the C-ring, by bringing the ancillary sleeve into contact with the C-ring from the other end side of the external sleeve and bringing the part of the intermediate sleeve not inserted into the external sleeve into contact with one end of the external sleeve, the intermediate sleeve can be securely fitted to the external sleeve.

Where a part of the ancillary sleeve or a part of the intermediate sleeve penetrating the C-ring comes into frictional contact with the C-ring, as the ancillary sleeve and the intermediate sleeve are prohibited from rotation in relation to each other, the threaded engagement between the ancillary sleeve and the intermediate sleeve is prevented from loosening, thereby resulting in secure fitting of the intermediate sleeve to the external sleeve.

The present disclosure relates to subject matter contained in Japanese Patent Application No. Hei 2000-401281, filed on Dec. 28, 2000, Japanese Patent Application No. Hei 2001-5638, filed on Jan. 12, 2001, and Japanese Patent Application No. Hei 2001-162133, filed on May 30, 2000, and which are expressly incorporated herein by reference in their entirety.

### BRIEF DESCRIPTION OF THE DRAWINGS

The foregoing and other purposes, aspects and advantages will be better understood from the following detailed description of preferred embodiments of the invention with reference to the drawings, in which:

FIG. 1 shows an overall view of a composite holding device 10;

FIG. 2 illustrates a holder body 12;

FIG. 3 shows a longitudinal section of the composite holding device 10, which is a first embodiment of the present invention;

FIG. 4 shows an expanded view of the cap 14 in FIG. 3;

FIG. 5 shows of exploded perspective views of the slide receptacle 40, slider 52, holder receptacle 50, and holder 21 (22);

FIG. 6 shows a section of an engaging piece of the slide receptacle 40 as viewed along line 6-6 in FIG. 3 (partly abridged for brevity of description);

FIG. 7 shows a section of the slide receptacle 40, holder receptacle 50, and slider 52 as viewed along line 7-7 in FIG. 3 (partly abridged for brevity of description);

FIG. 8 illustrates the slider 52 and holder receptacle 50 as viewed in the direction of arrow 8 in FIG. 3;

FIG. 9 shows a plan view of the holder receptacle 50;

FIG. 10(a) shows a longitudinal section of the slide receptacle 40, and FIG. 10(b) shows a section of the same as viewed in the direction of arrow b;

FIG. 11 shows an expansion plan of a cam face 32a of an intermediate sleeve 32;

FIG. 12 shows an expanded section of the fitting structure illustrated in FIG. 3;

FIGS. 13(a)-13(c) illustrate the intermediate sleeve 32 of the fitting structure shown in FIG. 3, with FIG. 13(a) showing a plan view, FIG. 13(b) showing a sectional view, and FIG. 13(c) showing another sectional view as viewed along 13c-13c in FIG. 13(a);

FIGS. 14(a) and 14(b) illustrate an internal sleeve 46 of the fitting structure shown in FIG. 3, with FIG. 14(a) showing a plan view, and FIG. 14(b) showing a sectional view;

FIG. 15 shows a section of an interim state of the assembly of the first embodiment of the invention, corresponding to the drawing shown in FIG. 12;

FIG. 16 shows a longitudinal section of a state in which one holder 21 is projected in the first embodiment of the invention;

FIG. 17 illustrates a state of use of the holder body in the first embodiment of the invention;

FIG. 18 shows a longitudinal section of a composite holding device, which is a second embodiment of the present invention;

FIG. 19 shows an expansion plan view of the cam face 32′a of the intermediate sleeve 32′;

FIG. 20 shows an explanatory perspective view of the second embodiment of the invention;

FIG. 21 shows a longitudinal section of the second embodiment of the invention in a state in which a mechanical pencil stem, which is one of the holders 62, is projected;

FIG. 22 illustrates a variation of the first embodiment of the invention provided with another holder body;

FIG. 23 shows a section of a structure in which the intermediate sleeve 32-1 of a third embodiment of the invention is fitted to the intermediate sleeve;

FIG. 24 shows a section of a variation of the third embodiment of the invention;

FIG. 25 shows a section of a structure in which the intermediate sleeve of a fourth embodiment of the invention is fitted to the internal sleeve;

FIG. 26 shows a front view of the C-ring 49 for use in the configuration shown in FIG. 25; and

FIG. 27 illustrates a variation of the slider according to invention, corresponding to the drawing shown in FIG. 3.

### DETAILED DESCRIPTION OF THE PREFERRED EMBODIMENTS

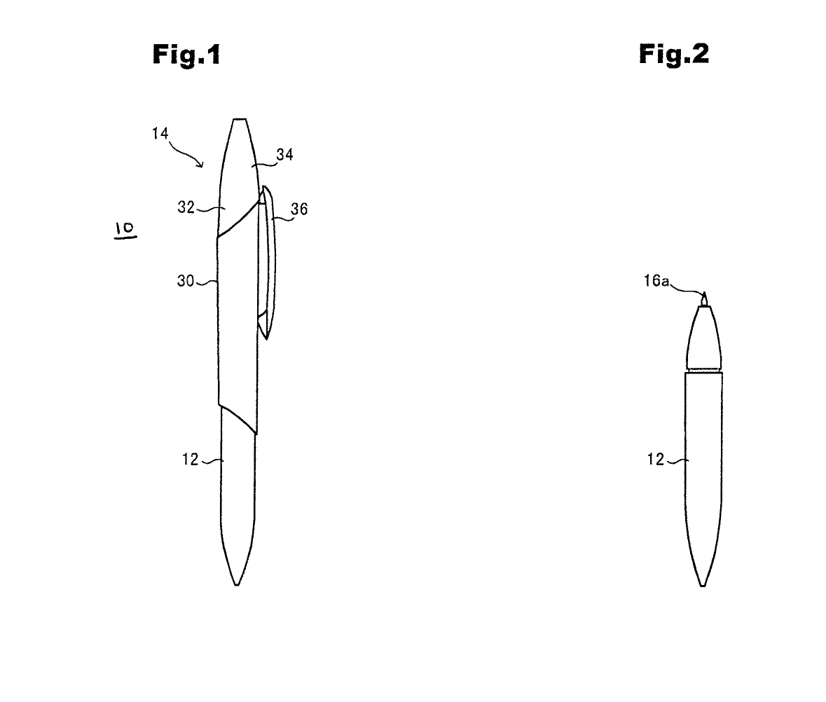

Embodiments of the present invention will be described below with reference to the accompanying drawings. FIGS. 1-17 illustrate a first embodiment of the present invention.

In the drawings, reference numeral 10 denotes a whole writing tool as an example of composite holding device according to the invention. The writing tool 10 is mainly provided with a holder body 12 and a cap 14 detachably covering the holder body 12. Into the holder body 12 is incorporated a refill 16 having a ball at a tip 16a and containing ink, thereby enabling holder body 12 to hold ink. The cap 14, which is intended to protect the tip 16a of the refill 16 to prevent the ink within from evaporating and drying when the refill 16 is not in use, also has a composite holding device built into it.

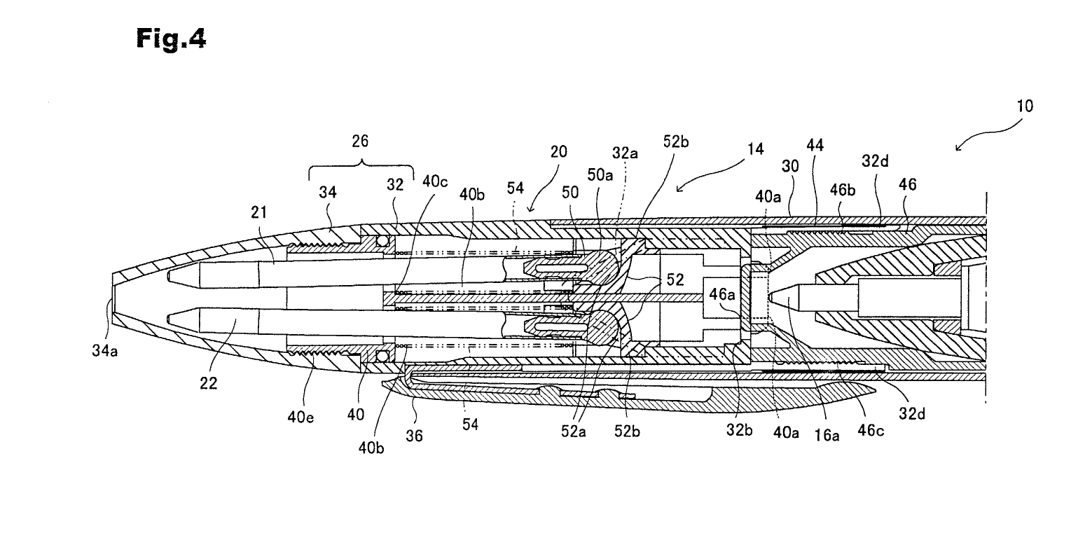

FIG. 4 shows an expanded view of the cap 14. The composite holding device built into the cap 14 is mainly provided with a casing 20 for accommodating a plurality of holders 21 and 22 substantially overlapping each other in the axial direction, a supporting section 23 for supporting a plurality of holders 21 and 22 to be movable in the axial direction within the casing 20, a feed mechanism 24, provided in the casing 20, for selectively projecting either one of the plurality of holders 21 and 22, and a manipulating mechanism 26 for working the feed mechanism 24, so that one or the other of the plurality of holders 21 and 22 can be selectively projected for use.

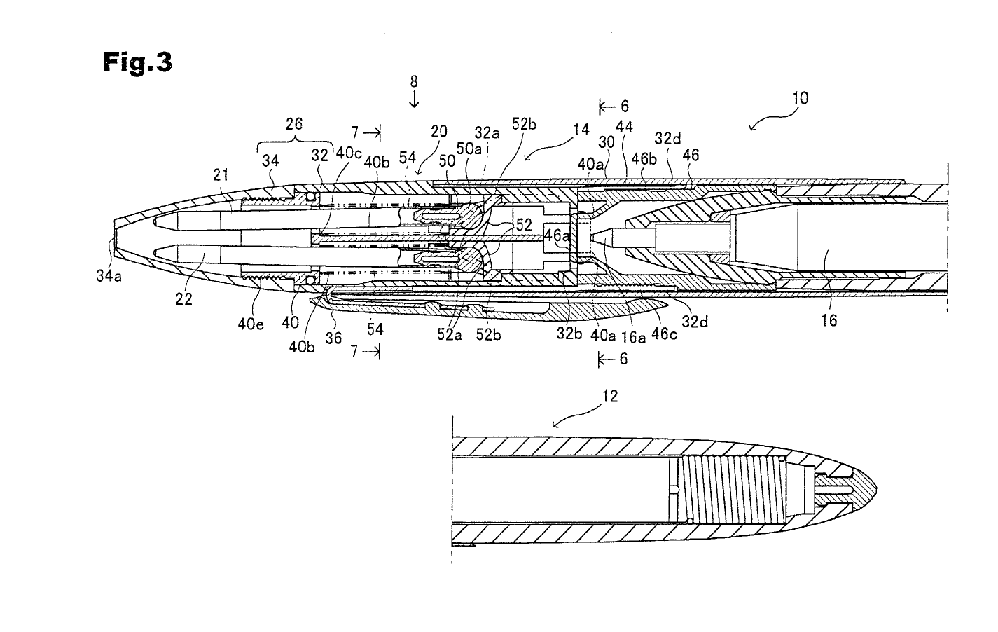

The holders 21 and 22 in the illustrated example are two ballpoint stems containing inks differing from each other either in color or property. The constituent mechanisms will be described in detail below. Hereinbelow, the cap 14 side in FIG. 3 represents the “fore side”, and the holder body 12 side represents the “rear side”.

The casing 20 includes an external sleeve 30, an intermediate sleeve 32 and a nose 34. The rear end of the intermediate sleeve 32 is inserted into the external sleeve 30 and fixed there, and inside the intermediate sleeve 32 is fixed an internal sleeve 46 to serve as the ancillary sleeve.

The intermediate sleeve 32, whereas it can be fixed to the external sleeve 30 by adhesion or any other desired binding means, in this embodiment is integrally fitted to the external sleeve 30 with the assistance of the internal sleeve 46 as will be described in detail hereinbelow. The internal space of the internal sleeve 46 accommodates the tip 16a of the refill 16 of the holder body 12 when the holder body 12 is protected by the cap 14.

As shown in FIG. 1, the boundary shape linking the tip of the intermediate sleeve 32 not inserted into the external sleeve 30 but exposed to the outside, and the tip of the external sleeve 30 to each other, is not a true circle normal to the axial direction, but preferably is an ellipse inclined at an angle to the axial direction. Therefore, the external sleeve 30 and the intermediate sleeve 32 cannot rotate in relation to each other, and at the tip part of the inclined boundary ellipse the base of a clip 36 is pinched between the intermediate sleeve 32 and the external sleeve 30. The intermediate sleeve 32, external sleeve 30 and clip 36 also can be integrally formed having a unitary construction.

The nose 34 is arranged on a side of the tip of, and to be capable of rotating in relation to, the intermediate sleeve 32. Namely, the nose 34 is threaded onto a threaded part 40e formed on the outer circumferential face of the tip of a slide receptacle 40 arranged within the intermediate sleeve 32 of the casing 20, and the nose 34 and the slide receptacle 40 rotate integrally in a state in which the nose 34 is threaded on the slide receptacle 40. The tip of either one of the holders 21 and 22 is selectively projected out of an fore end opening 34a at the tip of the nose 34.

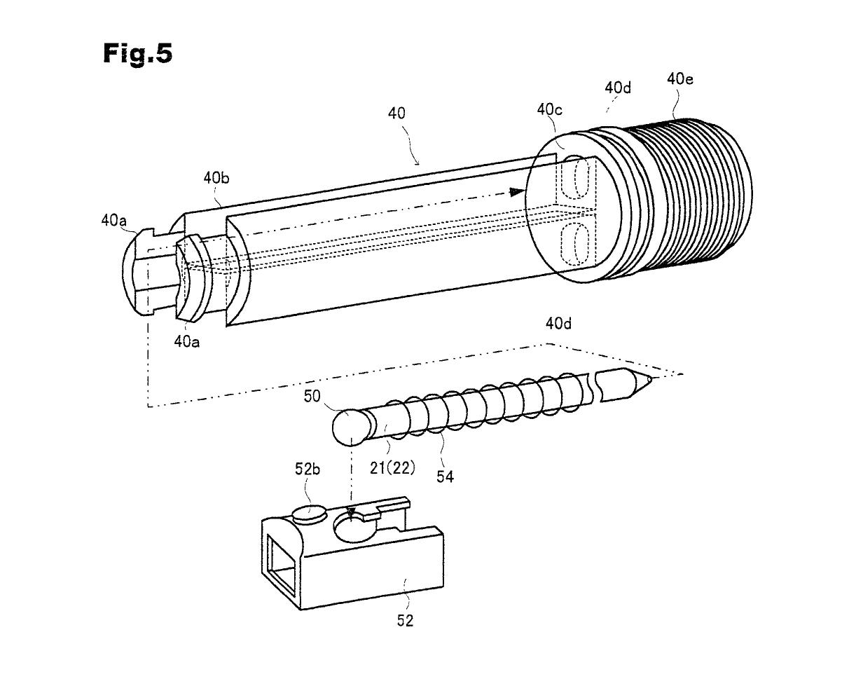

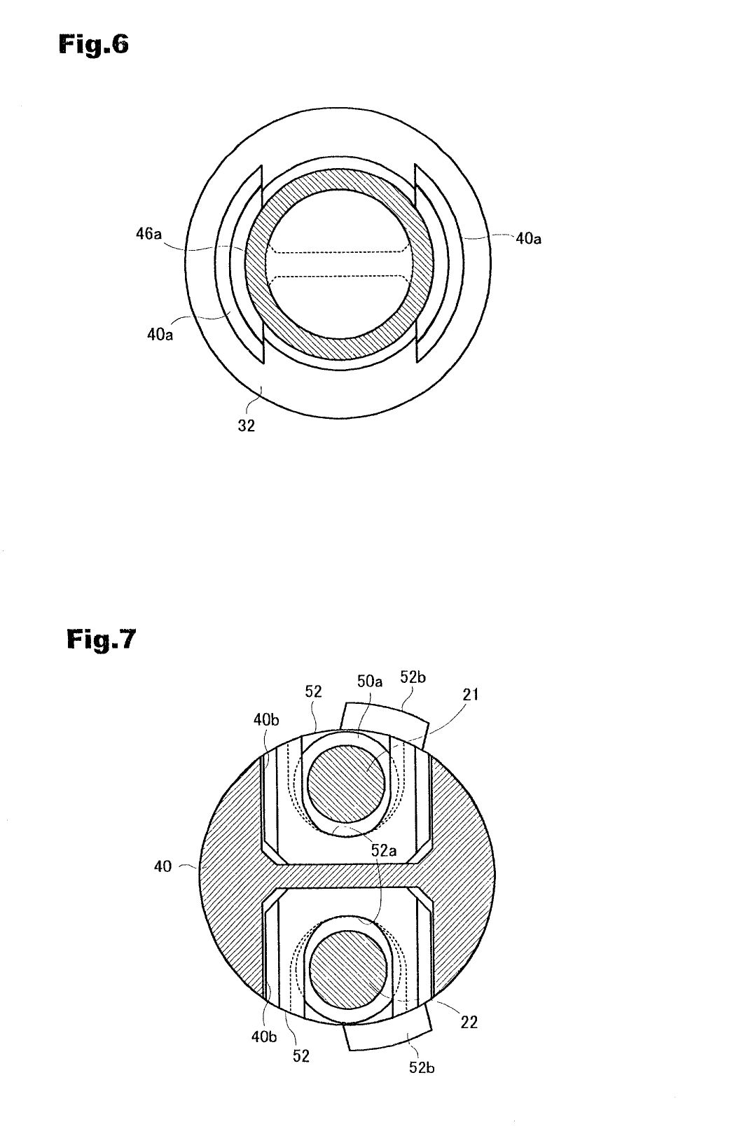

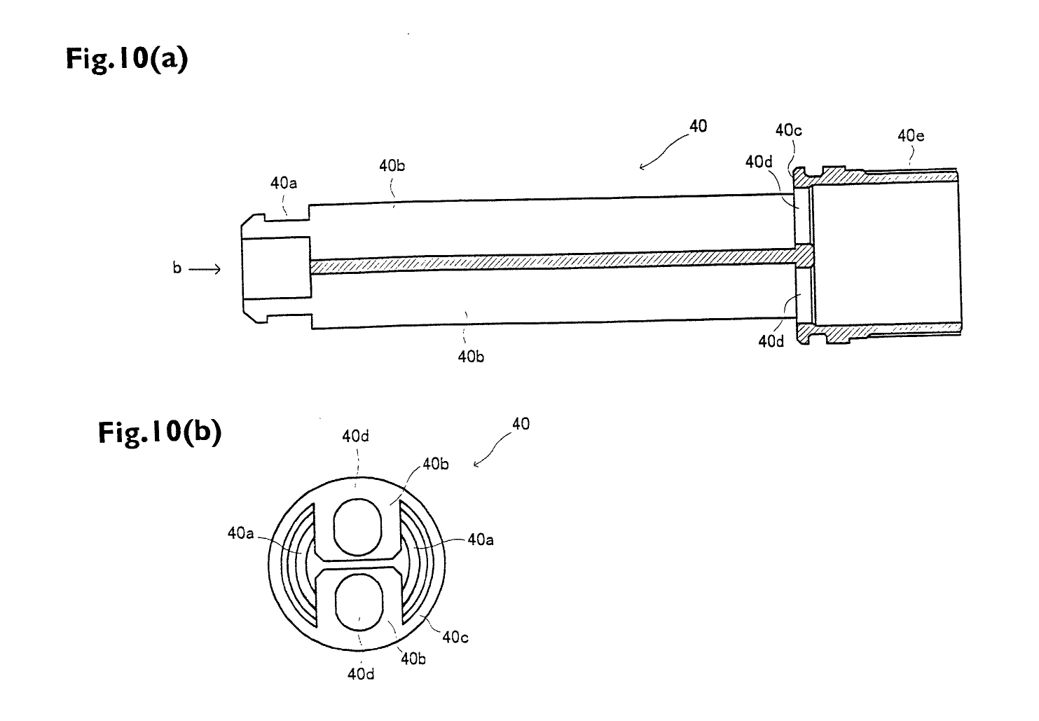

The slide receptacle 40 threaded into the nose 34 extends in the axial direction within the intermediate sleeve 32. As shown in FIGS. 5 and 10, at the rear end of the slide receptacle 40 are formed engaging pieces 40a and 40a, which are engaged with a stepped part 32b, formed at the rear end of the intermediate sleeve 32, to be rotatable relative thereto. Farther inside than the engaging pieces 40a and 40a in the radial direction is fitted a head part 46a of the internal sleeve 46 to prevent the engaging pieces 40a and 40a from falling inwardly in the radial direction and thereby not to let the engaging pieces 40a disengage the stepped part 32b (see FIG. 6).

Further, on the slide receptacle 40 are formed as many guide grooves 40b as the holders 21 and 22 to be accommodated extending in the axial direction, and the holders 21 and 22 are arranged within the respective guide grooves 40b to be movable in the axial direction. Namely, at the rear end of each of the holders 21 and 22 is provided a holder receptacle 50 as the supported section. The holder receptacle 50 is supported by a slider 52, which is the supporting section 23, and the slider 52 is slidably fitted into the guide groove 40b of the slide receptacle 40 (see FIG. 7).

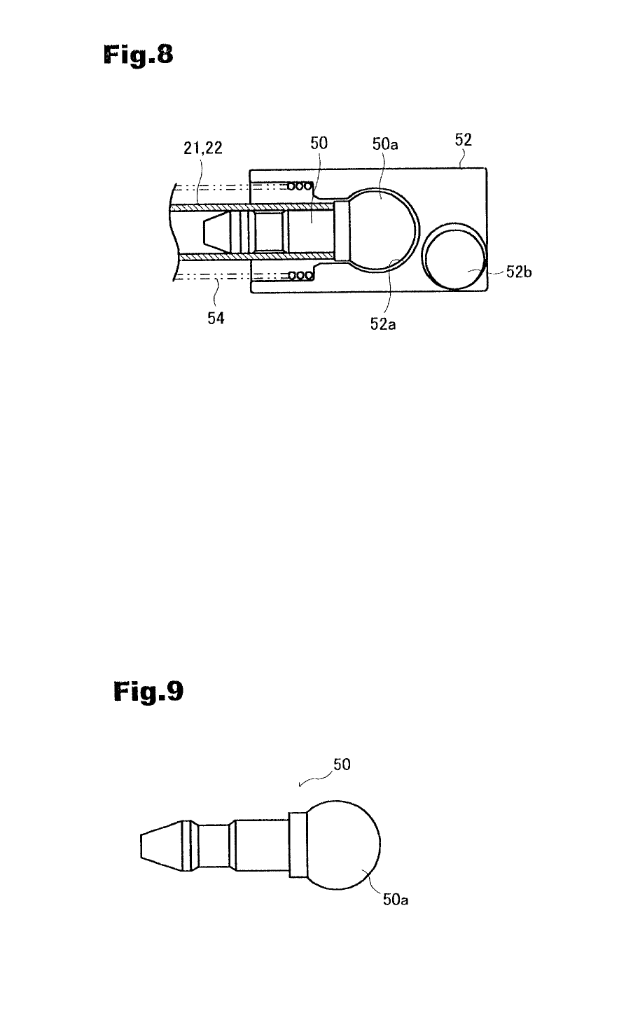

As shown in FIGS. 8 and 9, the tip of the holder receptacle 50 is inserted into a ballpoint stem, which is the holder 21 or 22, and its rear part constitutes a spherical part 50a. On the other hand, a concave part 52a for bearing the spherical part 50a is formed on its inner circumferential face of the slider 52. The spherical part 50a and the concave part 52a constitute a spherical bearing to rotatably bear the holder receptacle 50 with a freedom of angle in relation to the slider 52.

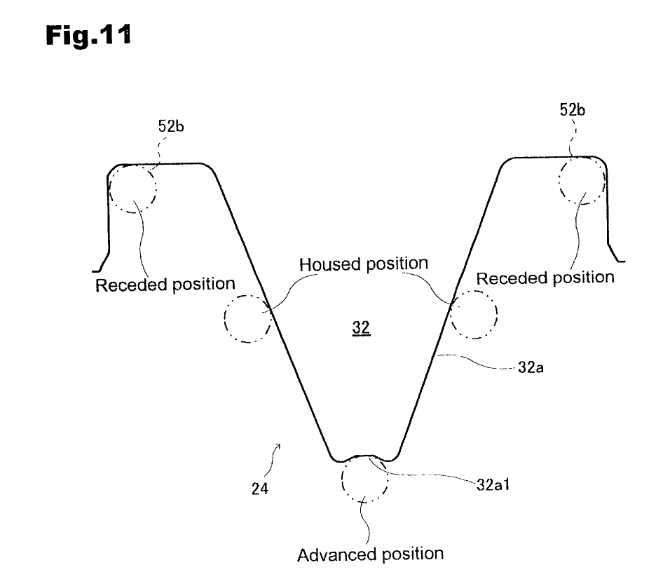

On the inner circumferential face of the front portion of the intermediate sleeve 32 is formed a cam face 32a including a forward step face and inclined in the axial direction, and a projection 52b of the slider 52 is in contact with this cam face 32a. This cam face 32a is substantially V-shaped as the expansion plan view of FIG. 11 shows, and its projecting end is positioned toward the tip. At this projecting end is formed an engaging part 32a1 constituting a small dent in the cam face 32a. The projection 52b of the slider 52 can slide along this cam face 32a. To ensure the contact of the slider 52 with the cam face 32a, a return spring 54 intervenes between the slider 52 and a partition wall 40c of the slide receptacle 40, so that the return spring 54 pushes the slider 52 backward.

As shown in FIG. 10, through holes 40d and 40d are formed on the partition wall 40c to let the holders 21 and 22 pass through, and each of the through holes 40d is not circular but elliptical, longer in the radial direction.

The above-described cam face 32a and the projection 52b of the slider 52 include the feed mechanism 24, and the nose 34 and the intermediate sleeve 32 (or the external sleeve 30) enabled to rotate in relation to each other include the manipulating mechanism 26.

As will be described in detail below, in order for the holders 21 and 22 to be projected and receded reliably, it is necessary for the intermediate sleeve 32, on which the cam face 32a is formed, to be securely fitted to and integrated with the external sleeve 30. The structure and method for this assembly will be described below.

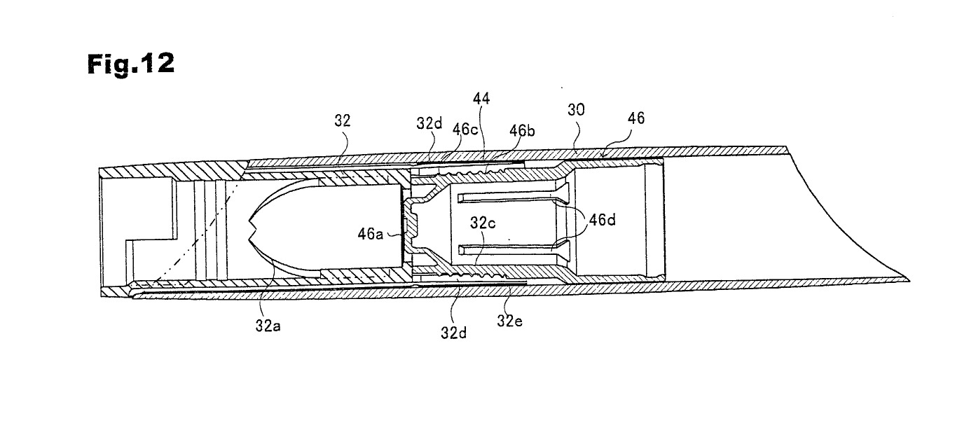

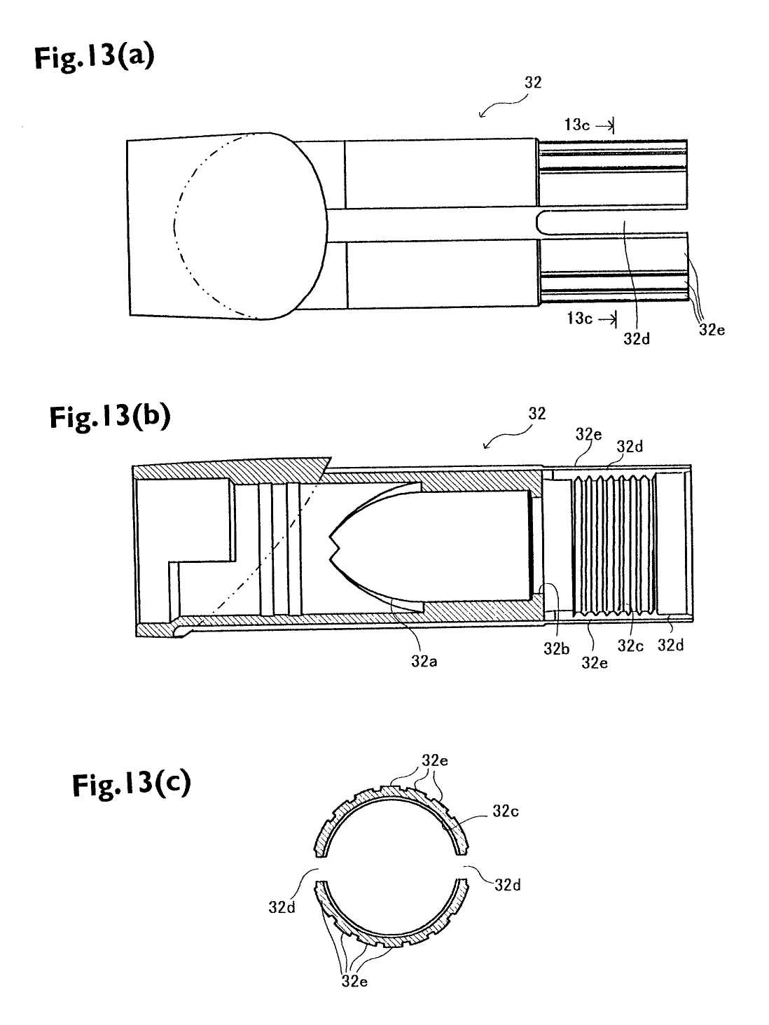

As shown in FIGS. 12 and 13, an internal thread 32c is formed on an inner circumferential face of the rear end of the intermediate sleeve 32, and on the intermediate sleeve 32 a pair of mutually opposite slits 32d, extending from the end part in the axial direction, are further formed on its internally threaded part where the internal thread 32c is formed. The number of slits 32d is not limited to two as in this case, but may be one, or three or more. Further on an outer circumferential face of the internally threaded part of the intermediate sleeve 32 are formed a plurality of projections 32e extending in the axial direction, appropriately separated from each other in the circumferential direction. Preferably, an elastic ring (elastic member) 44 may be mounted on the outer circumferential face of the internally threaded part of this intermediate sleeve 32. The elastic ring 44 may include an elastomer, soft synthetic resin or the like.

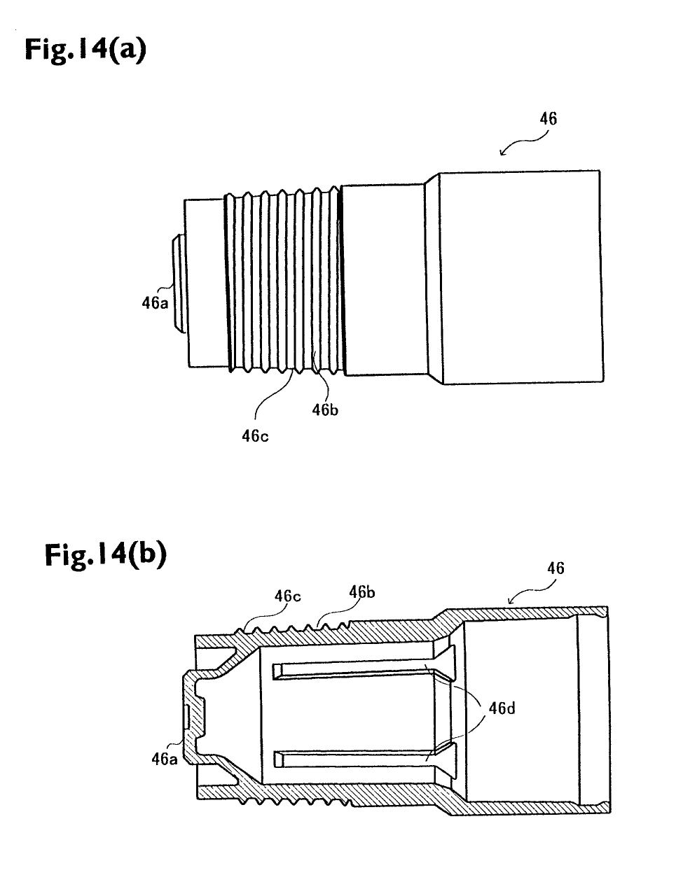

Further, as shown in FIGS. 12 and 14, on an outer circumferential face of the tip of (or a part of) an internal sleeve 46 is formed an external thread 46b to engage with the internal thread 32c, and an outer circumferential face of this externally threaded part constitutes a tapered face 46c whose external diameter gradually increases from the tip toward the rear part. Tool grooves 46d for letting in screw drivers and other tools for fitting use are also formed at appropriate intervals in the circumferential direction on an inner circumferential face of the internal sleeve 46.

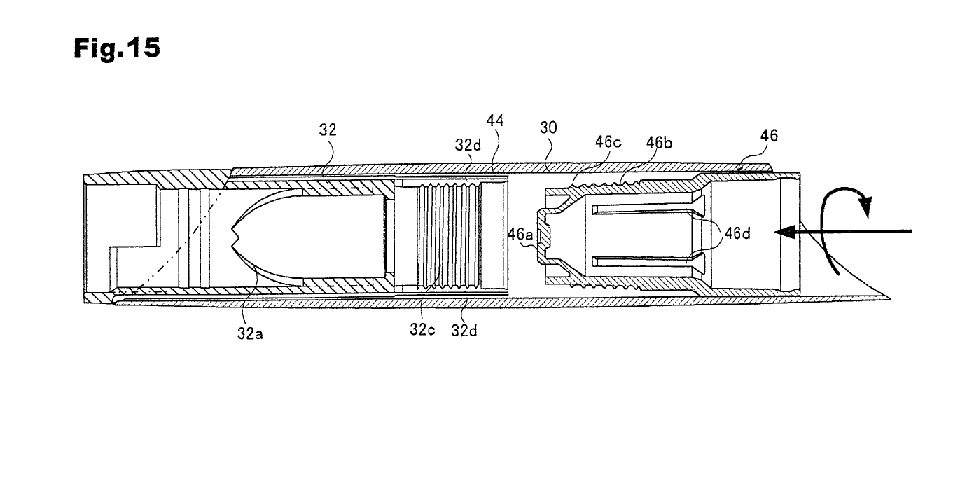

The assembly operation is performed as follows. First, the rear end of the intermediate sleeve 32 is inserted into the external sleeve 30 and set in a suitable position. Then, as shown in FIG. 15, the internal sleeve 46 is inserted into the external sleeve 30 and into the intermediate sleeve 32, and a tool is placed into the tool grooves 46d on the inner circumferential face of the internal sleeve 46 to turn the internal sleeve 46, thereby to screw the external thread 46b in the tip part of the internal sleeve 46 onto the internal thread 32c on the intermediate sleeve 32.

As the threading operation is continued, the tapered face 46c of the internal sleeve 46 expands the slits 32d at the rear end of the intermediate sleeve 32 to expand the internally threaded part of the intermediate sleeve 32 in the direction of the external diameter. As a result, the intermediate sleeve 32, especially its projections 32e, is pressed toward an inner circumferential face of the external sleeve 30. In this process, the elastic ring 44 mounted on the outer circumferential face of the internally threaded part of the intermediate sleeve 32 is compressed between the outer circumferential face of the intermediate sleeve 32 and the inner circumferential face of the external sleeve 30.

This causes the rear end of the intermediate sleeve 32 to be fitted to the inner circumferential face of the external sleeve 30, so that the intermediate sleeve 32 is firmly fixed to the external sleeve 30. Thus, the assembly operation can be accomplished efficiently, instead of taking a long time as adhesion would, without adversely affecting the appearance of the external sleeve 30. Further, as the projections 32e formed at appropriate intervals on the outer circumferential face of the intermediate sleeve 32 press the elastic ring 44 farther toward the inner circumferential face of the external sleeve 30, the friction may be increased with the inner circumferential face of the external sleeve 30 and accordingly the binding force.

However, a double or single-face adhesive tape can be set between the outer circumferential face of the intermediate sleeve 32 and the inner circumferential face of the external sleeve 30 in place of the elastic ring 44. The adhesive tape may be a pressure-sensitive adhesive tape. Where an adhesive tape is used, it may be preferable to dispense with the projections 32e on the outer circumferential face of the intermediate sleeve 32. Or, if desired, neither an adhesive tape nor the elastic ring 44 need be used, but instead the outer circumferential face of the intermediate sleeve 32 can be crimped directly onto the inner circumferential face of the external sleeve 30.

In the illustrated example, the outer circumferential face of the externally threaded part of the internal sleeve 46 is tapered. However, it is also conceivable to taper the inner circumferential face of the internally threaded part of the intermediate sleeve 32, so that the slits 32d of the intermediate sleeve 32 can be expanded as the screwing onto the internal sleeve 46 advances to expand the internally threaded part of the intermediate sleeve 32 in the direction of the external diameter.

The tips of both holders 21 and 22 of the cap 14 (into which the composite holding device configured as described above is incorporated) are positioned inwardly of the fore end opening 34a of the nose 34, and housed substantially overlapping each other in the axial direction in the state illustrated in FIG. 3. In this state, the projection 52b of the slider 52 supporting the holder receptacle 50 of each of the holders 21 and 22 is in an intermediate position of the cam face 32a (e.g., the position of accommodation in FIG. 11).

The use of either one of the holders 21 and 22 is accomplished in the following manner. Namely, the nose 34 is turned in a prescribed direction in relation to the intermediate sleeve 32, which causes the slide receptacle 40 integrated with the nose 34 to be turned in the prescribed direction in relation to the intermediate sleeve 32. As the sliders 52 and 52 fitted into the guide grooves 40b of the slide receptacle 40 also turn integrally, each of the projections 52b of the sliders 52 moves in the axial direction along the cam face 32a, and one of the two sliders 52 advances, whereas the other recedes.

If the holder receptacle 50 of the holder 21 is supported by the advanced slider 52, then the holder 21 will advance together with the slider 52. Then, the spherical part 50a of the holder receptacle 50 of the advanced holder 21, as the receptacle advances, comes into sliding contact with the concave part 52a and turns from the state in which the holder receptacle 50 is on the same straight line as the slider 52 is to become inclined and follow the movement of the tip of the holder 21.

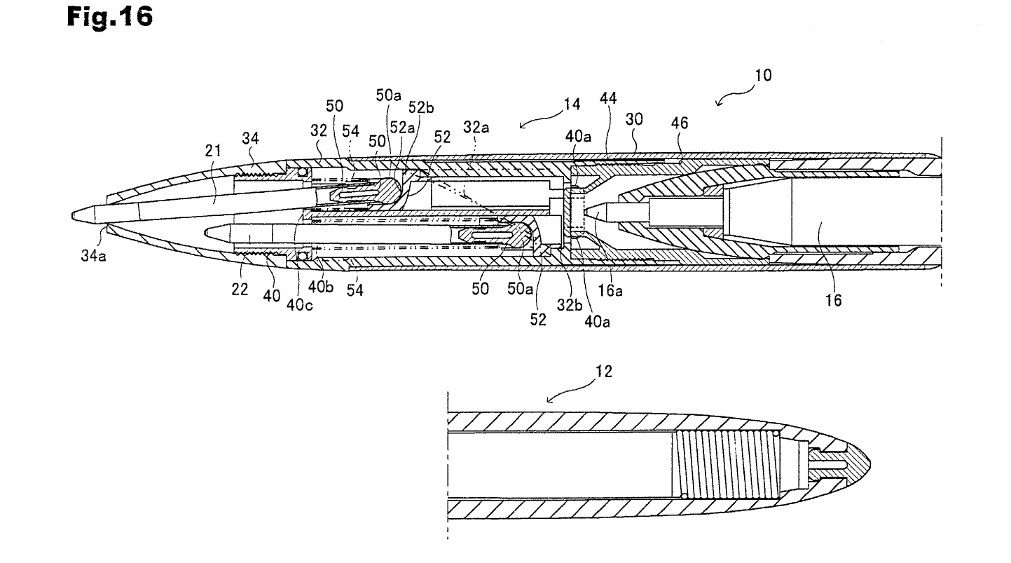

The tip of the holder 21, while moving along the inner circumferential face of the nose 34, projects out of the fore end opening 34a, which is on the axial line. The projection 52b of the slider 52 having advanced along the cam face 32a, when engaged with the engaging part 32a at the tip of the cam face 32a, stops in the position to which it has advanced (e.g., the advanced position in FIG. 11). In this way, the tip of the holder 21 supported by the slider 52 is held in a state of projection from the fore end opening 34a, as shown in FIG. 16, in which the holder 21 becomes usable. The slider 52 supporting the holder receptacle 50 of the other holder 22 recedes along the cam face 32a, and stops in the receded position shown in FIG. 11.

On the other hand, if the nose 34 is turned from the state shown in FIG. 3 in the direction reverse to the foregoing prescribed direction in relation to the intermediate sleeve 32, then the holder 22 will advance, whereas the holder 21 will recede. Then, the spherical part 50a of the holder receptacle 50 of the advanced holder 21, as the receptacle advances, comes into sliding contact with the concave part 52a of the corresponding slider 52 and turns in relation to the slider 52 to become inclined and follow the movement of the tip of the holder 22. The tip of the holder 22, while moving along the inner circumferential face of the nose 34, projects out of the fore end opening 34a, which is on the axial line, as in the above-described movement of the tip of the holder 21.

When the advanced holder 21 or 22 is to bereceded, turning the nose 34 in a reverse direction (e.g., the direction reverse to the direction in which it was turned when the holder 21 or 22 was to be advanced in relation to the intermediate sleeve 32), causes the projection 52b of the slider 52 supporting the advanced holder to recede in the axial direction along the cam face 32a and the projection 52b of the slider 52 holding the receded holder advances in the axial direction along the cam face 32a, thereby to return to the state shown in FIG. 3. The relationship between the spherical part 50a and the concave part 52a also returns to its original state.

Thus, the holders 21 and 22 can smoothly project and recede without being caught by the casing 20 or meeting resistance. Since the holders 21 and 22 can therefore project smoothly without having to be bent in themselves, the holders 21 and 22 can be kept short enough to be accommodated in the cap 14 which is not very long, and, for instance, hard metallic pipes can be used for the holders 21 and 22.

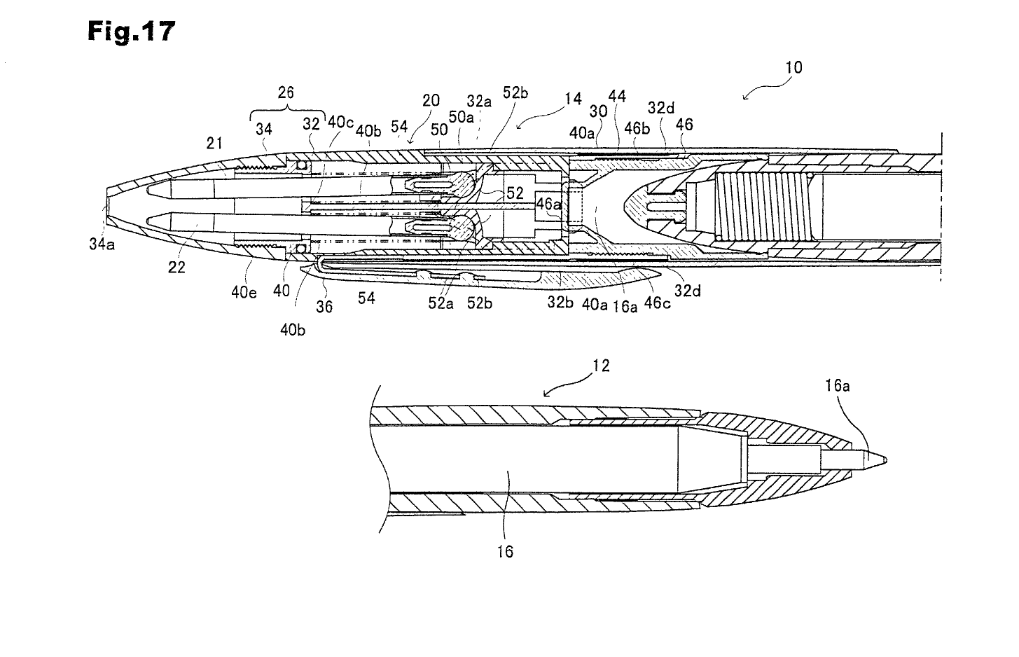

Now, when the holder body 12 of this writing tool 10 is to be used, by removing the cap 14 from the holder body 12 by a usual method and, as shown in FIG. 17, covering the rear end of the holder body 12 with the cap 14, the tip 16a of the refill 16 can be exposed to make writing possible with the tip 16a.

Hence, since not only the refill 16 built into the holder body 12 but also the plurality of holders 21 and 22 housed in the cap 14 can be selectively used, the range of applicability can be made broader than that of any existing composite holding device.

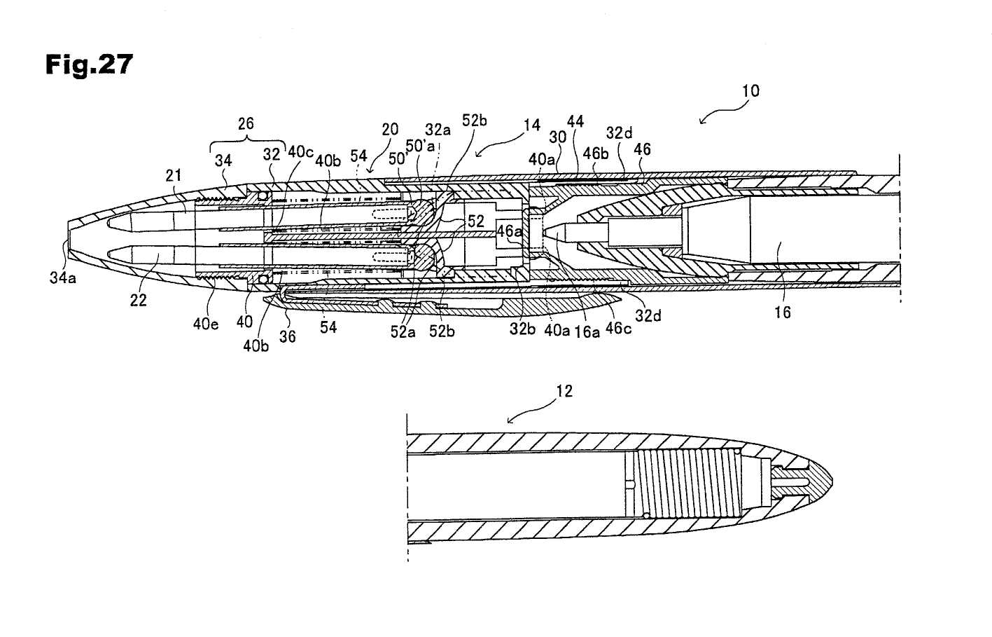

Although, in the foregoing example, the tip of the holder receptacle 50 is inserted into the holder 21 or 22 as shown in FIG. 3, FIG. 8 etc., the tip of a holder receptacle 50′ may as well cover the outside of the holder 21 or 22 as illustrated in FIG. 27. In this way, even where holders 21 and 22 are relatively short, their internal capacities can be sufficiently secured.

Second Embodiment

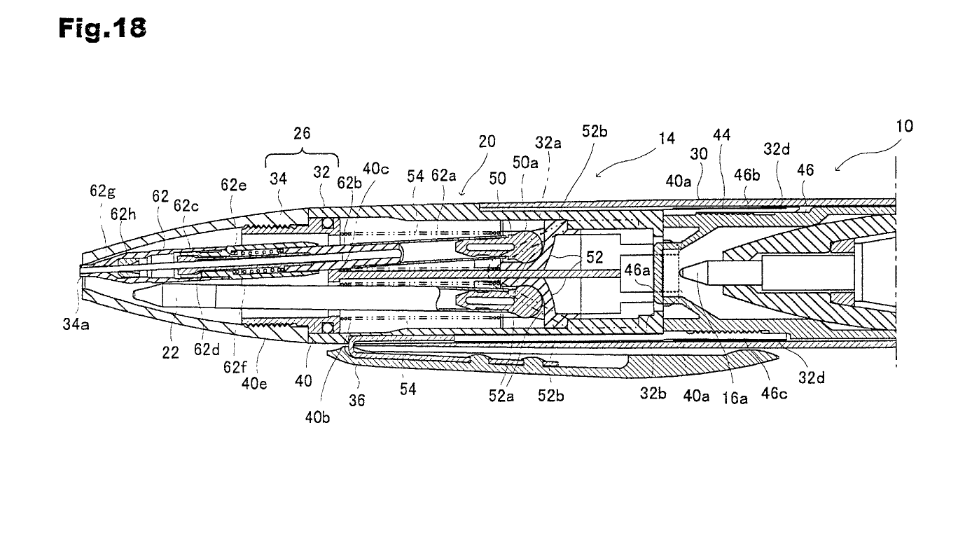

FIG. 18 illustrates a second embodiment of the present invention, wherein the same members as in the first embodiment are assigned respectively the same reference numbers, and their detailed description will be omitted.

In the second embodiment, one of holders 62 is a mechanical pencil stem and the other holder 22 is a ballpoint stem as in the first embodiment. The holder 62, which is a mechanical pencil stem, is configured of a lead tank 62a for accommodating leads, a coupling 62b to be linked to the lead tank 62a, a chuck 62c whose rear end is to be pressed into the coupling 62b, a chuck ring 62d to be fitted around the head of the chuck 62c, a sleeve 62e to regulate the rear end position of the chuck ring 62d, a return spring 62f intervening between the sleeve 62e and the coupling 62b, a nose 62g to be connected to the sleeve 62e, and a packing 62h provided within the nose 62g.

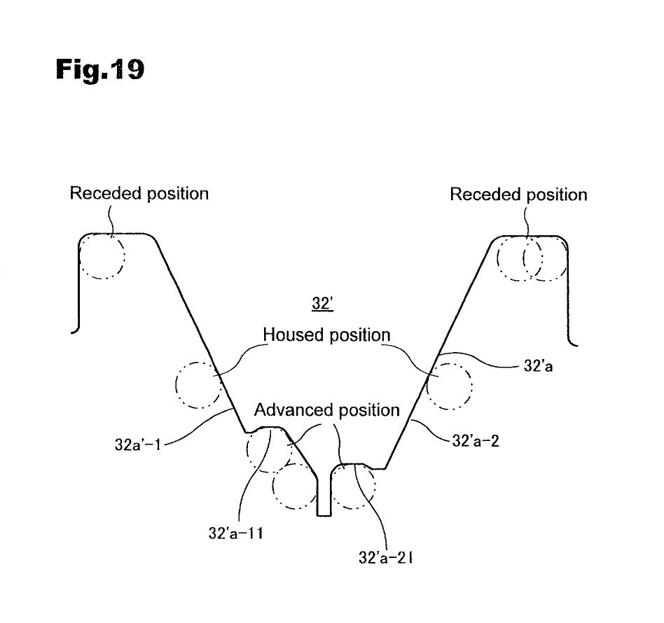

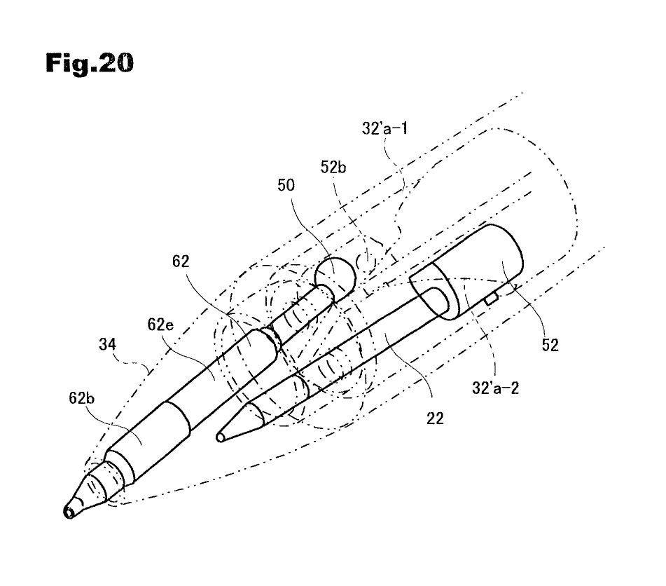

Further, in the second embodiment, a cam face 32′a of an intermediate sleeve 32′, as shown in FIG. 19 and FIG. 20, is divided into a cam face part 32′a-1 on which the slider 52 corresponding to the mechanical pencil stem 62 slides and a cam face part 32′a-2 on which the slider 52 corresponding to the ballpoint stem 22 slides. In a position somewhat rearwardly from the tip of the cam face part 32′a-1, an engaging part 32′a-11 , which is formed, for example, by a small dent, is formed on the cam face part 32′a-1, and in the tip position of the cam face part 32′a-2, an engaging part 32′a-21, which is formed, for example, by a small dent, is formed on a cam face 32′b.

In this embodiment, the tip of the ballpoint stem 22 is projected similarly as in the first embodiment. When the mechanical pencil stem 62 is to be projected, the nose 34 is turned in a prescribed direction in relation to the intermediate sleeve 32′, causes the slide receptacle 40 integrated with the nose 34 to turn in the prescribed direction in relation to the intermediate sleeve 32′.

As the sliders 52 and 52 fitted into the guide grooves 40b of the slide receptacle 40 also turn integrally, each of the projections 52b of the sliders 52 moves in the axial direction along the cam face 32′a. The projection 52b of the slider 52 supporting the holder receptacle 50 of the mechanical pencil stem 62 advances along the cam face part 32′a-1, and the tip of the mechanical pencil stem 62 projects out of the fore end opening 34a of the nose 34.

In this operation, when the projection 52b approaches the engaging part 32a-11, the nose 62g of the mechanical pencil stem 62 comes into contact with the surrounding around the fore end opening 34a of the nose 34, beyond which it can advance no farther. Further, the lead tank 62a, coupling 62b, chuck 62c and chuck ring 62d advance in relation to the nose 62g and the sleeve 62e, and a lead is fed by a known method.

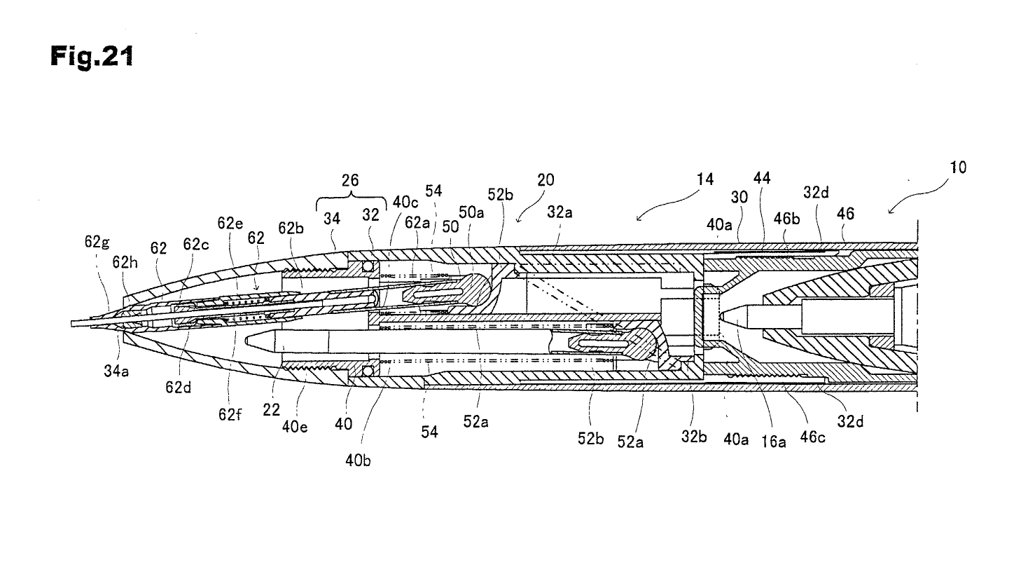

When the force to turn the nose 34 is decreased, the spring forces of the return spring 54 and another return spring 62f cause the projection 52b of the slider 52 supporting the mechanical pencil stem 62 to recede to the engaging part 32′a-11 and, as shown in FIG. 21, the tip of the mechanical pencil stem 62 is held in a position of projecting out of the fore end opening 34a. Further feeding of the lead by a prescribed length at a time is performed by turning the nose 34 in a prescribed direction and thereby moving back and forth the projection 52b of the slider 52 supporting the mechanical pencil stem 62 between the position of the engaging part 32′a-1 and the tip of the cam face part 32′a-1.

In this embodiment, the tip of the holder, which is the mechanical pencil stem 62, can smoothly project out of and recede into the fore end opening 34a of the casing 20 without being caught by the casing 20 or meeting resistance as the spherical part 50a of its holder receptacle 50 is borne by the concave part 52a of the slider 52. Furthermore, since the mechanical pencil stem 62 need not be bent, the lead feed mechanism including the chuck can be prevented from damage such as rupture, bending or lead breaking.

In addition to the above-described embodiments of the invention, the holder may be provided as a stylus pen stem holding a stylus tip, an eraser stem holding an eraser, a stick glue stem holding a stick glue, or a cosmetic stem holding a cosmetic such as a lipstick. Any of these stylus pen stem, eraser stem and cosmetic stem can be configured similarly to the ballpoint stem. However, where the holder holds an expendable item such as an eraser or a cosmetic, the eraser or cosmetic may be held by a needle and the needle is made feedable like the lead in the mechanical pencil stem so that the eraser or cosmetic can be fed.

Further, although the foregoing description of this embodiment assumed the use of two holders, the number of holders is not limited to two, but obviously the invention can as well be applied to a case in which three or more holders are to be housed in the casing 20.

Furthermore, in the foregoing description of this embodiment the supported section provided in each holder is formed as a spherical part and the slider, which is the supporting section, is formed as a concave part to receive the spherical part. However, a converse arrangement in which the slider is formed as a spherical part and a concave part to receive that spherical part is formed on the supported section of the holder may also may be used.

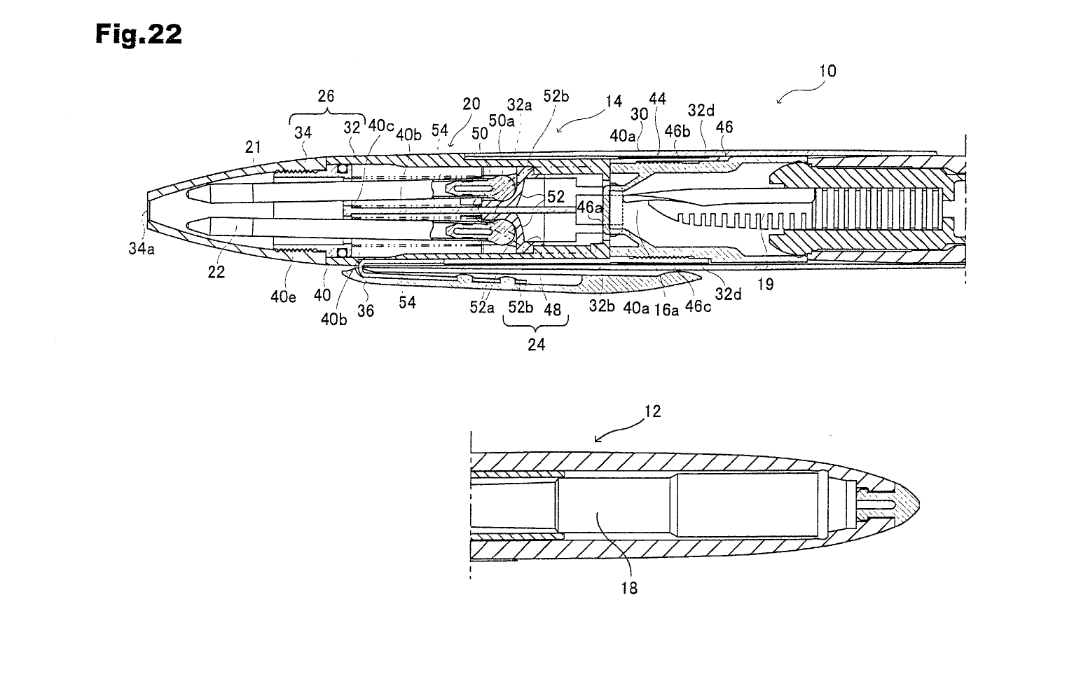

Further, as shown in FIG. 22, the structure could incorporate a cartridge 18 for containing ink and a pen core unit 19 with which the cartridge 18 is to be coupled can be incorporated into the holder body 12. In this arrangement, writing with the pen core unit 19 can be performed by removing the cap 14 to expose the tip of the pen core unit 19 and putting the cap 14 over the rear end of the holder body 12. As described above, various combinations of the medium held by the holder body 12 and media held by the holders housed in the cap 14 can be realized. However, the possible combinations are not confined to these, and indeed a writing tool may obviously include only the composite holding device described with reference to the conventional structure.

Third Embodiment

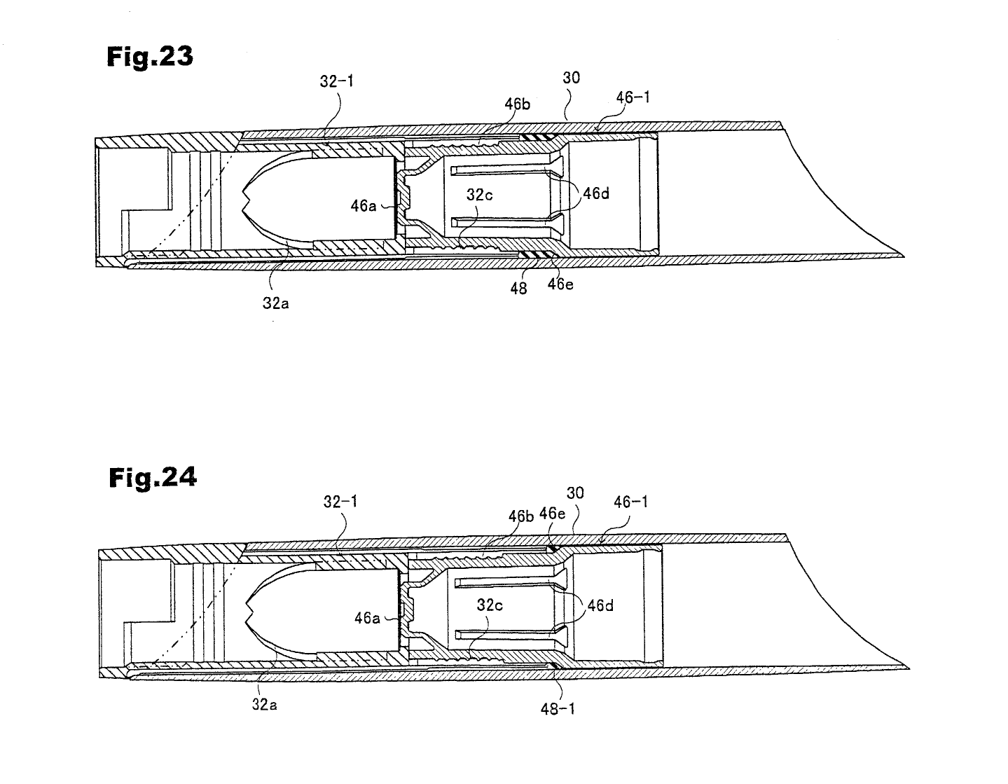

FIG. 23 illustrates the structure of a third embodiment of the invention in which the intermediate sleeve 32 is fitted to the external sleeve 30. In FIG. 23, the same members as in the first embodiment are assigned respectively the same reference numerals, and their detailed description will be omitted.

This embodiment differs from the first embodiment in that an elastic ring 48 is arranged adjoining an intermediate sleeve 32-1 within the external sleeve 30. Thus, the elastic ring 48 intervenes between a rear end face of the intermediate sleeve 32-1 and a step face 46e formed on an outer circumferential face in the part of the internal sleeve 46-1 not inserted into the intermediate sleeve 32-1. The elastic ring 48 may include an elastomer, soft synthetic resin or the like.

Slits 32d may be formed on the rear end part of the intermediate sleeve 32-1 as in the first embodiment. However, in this third embodiment, the slits 32d also could be dispensed with.

The step face 46e of the internal sleeve 46-1 may be a vertical face normal to the axial direction, but more preferably is inclined. The inclined face preferably should face the elastic ring 48 as well as the direction of the external diameter. The outer circumferential face in the tip part of the internal sleeve 46-1 need not be tapered like the tapered face 46c in the first embodiment, but may be parallel to the axial direction.

Assembly work for this embodiment is carried out in the following manner. First, the rear end of the intermediate sleeve 32-1 is inserted into the external sleeve 30 and set in a suitable position, and similarly the elastic ring 48 is inserted into the external sleeve 30 and positioned adjacent to the intermediate sleeve 32-1. Then, the internal sleeve 46-1 is inserted into the external sleeve 30 and into the intermediate sleeve 32-1, and a tool is placed into the tool grooves 46d on the inner circumferential face of the internal sleeve 46-1 to turn the internal sleeve 46-1, thereby to thread the external thread 46b in the tip part of the internal sleeve 46-1 onto the internal thread 32c on the intermediate sleeve 32-1.

As the threading is continued and the internal sleeve 46-1 is moved toward the intermediate sleeve 32-1, the step face 46e of the internal sleeve 46-1 comes into contact with the rear end of the elastic ring 48, and the elastic ring 48, pinched between the intermediate sleeve 32-1 and the step face 46e of the internal sleeve 46-1, is compressed in the axial direction. This causes the elastic ring 48 to expand in the radial direction, and to press against the inner circumferential face of the external sleeve 30. In this process, as the step face 46e of the internal sleeve 46-1 is inclined, the elastic ring 48 is progressively pressed in the direction of the external diameter as the step face 46e approaches the elastic ring 48.

Hence, the elastic ring 48 is fixed within the external sleeve 30. Further, as the intermediate sleeve 32-1 and the internal sleeve 46-1 are threaded onto each other to pinch the elastic ring 48 between them, the rear end of the intermediate sleeve 32-1 becomes immovable in relation to the external sleeve 30, so that the intermediate sleeve 32-1 is firmly fitted to the external sleeve 30.

The compressed elastic ring 48 is subjected to expansion forces in all directions, and the elastic ring 48, elastically in contact with the intermediate sleeve 32-1 and the internal sleeve 46-1, causes frictional forces to arise between them. These frictional forces prevent the intermediate sleeve 32-1 and the internal sleeve 46-1 from being rotationally moved inadvertently, and the threaded fitting between the internal sleeve 46-1 and the intermediate sleeve 32-1 is prevented from loosening.

The elastic ring 48 need not be long in the axial direction. That is, obviously a short O-ring 48-1 could similarly function as shown in FIG. 24 as a variation of the third embodiment of the invention.

In the embodiments illustrated in FIG. 23 and FIG. 24, the intermediate sleeve 32-1 and the internal sleeve 46-1 are linked together by threaded engagement of the internal thread 32c of the intermediate sleeve 32-1 and the external thread 46b of the internal sleeve 46-1 with each other. However, the linking arrangement is not limited thereto. An external thread also could be formed on the intermediate sleeve, and an internal thread to engage with the external thread on the intermediate sleeve, may be formed on the internal sleeve. Further, the rear end part of the intermediate sleeve, instead of the tip part of the internal sleeve, could be caused to penetrate the elastic ring 48 to link the intermediate sleeve and the internal sleeve.

Fourth Embodiment

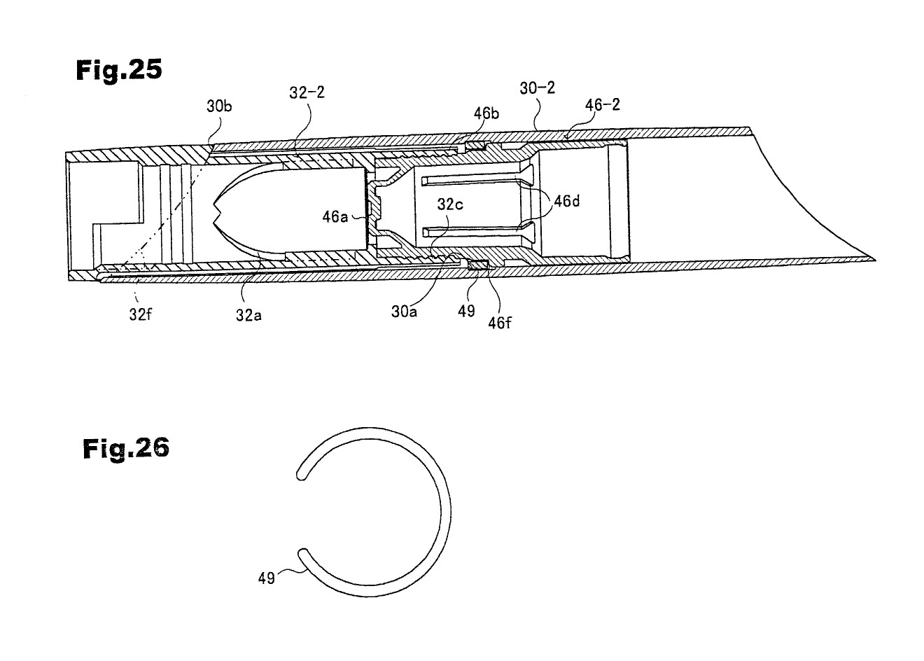

Next, FIG. 25 illustrates a fourth embodiment of the present invention. In the drawing, the same members as in the first and third embodiments are assigned respectively the same reference numerals, and thus their detailed description will be omitted.

On an inner circumferential face of the external sleeve 30-2 in this embodiment is formed an annular concave part 30a. Into this annular concave part 30a is fitted a C-ring 49. The C-ring 49, which may be made of either metal or resin, has one cut part as shown in FIG. 26, and can be deformed by either expansion or compression in the radial direction. Therefore, when the C-ring 49 is to be fitted into the annular concave part 30a of the external sleeve 30-2, it can be accomplished by shifting the C-ring 49 within the external sleeve 30-2 to the annular concave part 30a while compressing it in the direction of the internal diameter. The C-ring 49, in the state of being fitted into the annular concave part 30a, the most inward part of the C-ring 49 projects more in the direction of the internal diameter than any part of the inner circumferential face other than the annular concave part 30a of the external sleeve 30-2.

A step face 46f to be in contact with the C-ring 49 projecting in the direction of the internal diameter is formed on the outer circumferential face of the internal sleeve 46-2.

There is no need to form slits 32d, like those in the first embodiment, at the rear end of the intermediate sleeve 32-2. Further, it is unnecessary to taper the outer circumferential face of the tip of the internal sleeve 46-2 like the tapered face 46c in the first embodiment.

Assembly work for this embodiment is carried out in the following manner. First, the C-ring 49 is fitted in advance in the annular concave part 30a of the external sleeve 30-2 as described above. Then, the rear end of the intermediate sleeve 32-2 is inserted from the tip of the external sleeve 30-2 to bring into contact a step face 32f, which forms the boundary line between the tip part and the rear end part of the intermediate sleeve 32-2, with the tip face 30b of the external sleeve 30-2. Preferably, then, the rear end part of the intermediate sleeve 32-2, which is its inserted end, and the C-ring 49 are separated from each other in the axial direction.

Then, the internal sleeve 46-2 is inserted from the rear end of the external sleeve 30-2, and the tip of the internal sleeve 46-2 is caused to penetrate the C-ring 49 and inserted into the intermediate sleeve 32-2. A tool is placed into the tool grooves 46d on the inner circumferential face of the internal sleeve 46-2 to turn the internal sleeve 46-2, thereby to thread the external thread 46b in the tip part of the internal sleeve 46-2 onto the internal thread 32c on the intermediate sleeve 32-2.

As the threading is continued and the internal sleeve 46-2 is moved toward the intermediate sleeve 32-2, the step face 46f of the internal sleeve 46-2 comes into contact with the rear end of the C-ring 49, and the internal sleeve 46-2 can be moved no farther toward the intermediate sleeve 32-2. In this state, the intermediate sleeve 32-2 and the internal sleeve 46-2 linked by the threading pinch between the tip face 30b of the external sleeve 30-2 and the rear end face of the C-ring 49, with the result that the intermediate sleeve 32-2 is firmly fitted to the external sleeve 30-2.

In this embodiment, the intermediate sleeve 32-2 can be more firmly fitted to the external sleeve 30-2. Further, where the internal diameter of the C-ring and the external diameter of the tip part of the internal sleeve 46-2 are so set that the tip part of the internal sleeve 46-2 penetrating the C-ring 49 come into contact with the inner circumferential face of the C-ring 49, frictional forces arise between them. These frictional forces prevent the internal sleeve 46-2 from being turned inadvertently, thereby preventing the threaded fitting between the internal sleeve 46-2 and the intermediate sleeve 32-2 from loosening.

In the embodiment illustrated in FIG. 25, the intermediate sleeve 32-2 and the internal sleeve 46-2 are linked together by threaded engagement of the internal thread 32c of the intermediate sleeve 32-2 and the external thread 46b of the internal sleeve 46-2 with each other, but the linking arrangement is not limited thereto. An external thread could be formed on the intermediate sleeve, and an internal thread to engage with the external thread on the intermediate sleeve, on the internal sleeve may be formed. The rear end part of the intermediate sleeve (instead of the tip part of the internal sleeve) could be caused to penetrate the C-ring 49 to link the intermediate sleeve and the internal sleeve.

While the invention has been described in terms of several preferred embodiments, those skilled in the art will recognize that the invention can be practiced with modification within the spirit and scope of the appended claims.

What is claimed is:

1. A composite holding device, comprising:
a casing for accommodating a plurality of holders for holding media to serve either different or similar purposes;
a supporting section for supporting said holders to be movable in an axial direction in the casing;
a feed mechanism, provided in the casing, for selectively advancing one of the plurality of holders; and
a manipulating mechanism for operating the feed mechanism, to project the tip of one of the plurality of holders out of a fore end opening at the tip of the casing and make usable the tip of one of the plurality of holders,
wherein a supported section of each holder supported by said supporting section is rotatably supported in relation to the supporting section.

2. The composite holding device, as set forth in claim 1, further comprising a spherical bearing formed between said supporting section and the supported section provided on each of said holders.

3. The composite holding device, as set forth in claim 2, wherein said spherical bearing includes a spherical part formed on either one of said supporting section and the supported section provided on a holder and a concave part formed on the other one of said supporting section and supported section provided on the holder to receive said spherical part.

4. The composite holding device, as set forth in claim 1, wherein said media are selected from a group of media consisting of writing-related media including a pencil lead, an ink, a stick glue, an eraser and a correctional fluid, cosmetic media including a lipstick, an eye pencil, an eyeliner and an eyebrow pencil, and data inputting media including a stylus tip.

5. A writing tool comprising a cap into which the composite holding device set forth in claim 1 is built.

6. A composite holding device, comprising:
a holder body for holding a medium to serve a prescribed purpose; and
a cap for covering the holder body,
wherein the cap comprises:
a casing for accommodating a plurality of holders, each holder for holding a medium to serve a purpose either different from or similar to that of said medium;
a supporting section for supporting said holders to be movable in an axial direction in the casing;
a feed mechanism, provided in the casing, for selectively advancing one of the plurality of holders; and
a manipulating mechanism for operating the feed mechanism, to project the tip of one of the plurality of holders out of a fore end opening at the tip of the casing and make usable the tip of one of the plurality of holders.

7. The composite holding device, as set forth in claim 6, wherein a supported section of each holder supported by said supporting section is rotatably supported in relation to the supporting section.

8. The composite holding device, as set forth in claim 6, further comprising:
a spherical bearing formed between said supporting section and a supported section provided on each of said holders.

9. The composite holding device, as set forth in claim 8, wherein said spherical bearing includes:
a spherical part formed on either one of said supporting section and a supported section provided on a holder; and
a concave part formed on the other one of said supporting section and supported section provided on the holder to receive said spherical part.

10. The composite holding device, as set forth in claim 6, wherein said media are selected out of a group of media consisting of writing-related media including a pencil lead, an ink, a stick glue, an eraser and a correctional fluid, cosmetic media including a lipstick, an eye pencil, an eyeliner and an eyebrow pencil, and data inputting media including a stylus tip.

11. The composite holding device, as set forth in claim 1, wherein:
said casing comprises an external sleeve, an intermediate sleeve fitted inside the external sleeve with assistance of an ancillary sleeve, and a nose rotatable in relation to the external sleeve and the intermediate sleeve;
an internal thread is formed on an inner circumferential face of the intermediate sleeve and a slit is formed on the internally threaded part of the intermediate sleeve;
an external thread is formed on an outer circumferential face of the ancillary sleeve;
one of the externally threaded part of the ancillary sleeve and the internally threaded part of the intermediate sleeve has a tapered shape; and
the external thread of said ancillary sleeve inserted into the external sleeve and the intermediate sleeve engages the internal thread of the intermediate sleeve inserted into the external sleeve, the slit of the intermediate sleeve being expanded to press the internally threaded part against an inner circumferential face of the external sleeve to fix the intermediate sleeve to the external sleeve, thereby to fit the intermediate sleeve inside the external sleeve.

12. The composite holding device, as set forth in claim 11, wherein a projection to be pressed against the inner circumferential face of the external sleeve is formed on an outer circumferential face of the internally threaded part of said intermediate sleeve.

13. The composite holding device, as set forth in claim 11, wherein one of an adhesive tape and an elastic member is positioned between the outer circumferential face of the internally threaded part of said intermediate sleeve and the inner circumferential face of the external sleeve.

14. The composite holding device, as set forth in claim 1, wherein:
said casing comprises an external sleeve, an intermediate sleeve fitted inside the external sleeve with assistance of an ancillary sleeve and an elastic ring, and a nose rotatable in relation to the external sleeve and the intermediate sleeve;
an internal thread is formed on either one of the intermediate sleeve and the ancillary sleeve, and an external thread to engage the internal thread is formed on the other one of the intermediate sleeve and the ancillary sleeve;
the intermediate sleeve and the elastic ring adjacent to the intermediate sleeve in the axial direction, are inserted into the external sleeve, the ancillary sleeve is inserted into the external sleeve from the elastic ring side, one of a part of the ancillary sleeve and a part of the intermediate sleeve penetrates the elastic ring, the threaded engagement of said external thread and internal thread with each other serves to combine the intermediate sleeve and the ancillary sleeve, and the elastic ring is compressed in the axial direction between the ancillary sleeve and the intermediate sleeve to be pressed against an inner circumferential face of the external sleeve and thereby to be fixed to the external sleeve, thereby resulting in the fitting of the intermediate sleeve inside the external sleeve.

15. The composite holding device, as set forth in claim 14, wherein a step face for coming into contact with said elastic ring is formed on said ancillary sleeve, and the step face is inclined in relation to the direction of the external diameter.

16. The composite holding device, as set forth in claim 1, wherein:
said casing comprises an external sleeve, an intermediate sleeve fitted inside the external sleeve with the assistance of an ancillary sleeve and a C-ring, and a nose rotatable in relation to the external sleeve and the intermediate sleeve;
an annular concave part is formed on an inner circumferential face of the external sleeve, and the C-ring is fitted into the annular concave part to project more in the direction of the internal diameter than the inner circumferential face of the external sleeve;
an internal thread is formed on either one of the intermediate sleeve and the ancillary sleeve, and an external thread to engage the internal thread is formed on the other one of the intermediate sleeve and the ancillary sleeve;
a part of the intermediate sleeve is inserted into the external sleeve from one end of the external sleeve, and the other part of the intermediate sleeve not inserted into the external sleeve is brought into contact with the one end of the external sleeve; and
the ancillary sleeve is inserted into the external sleeve from the other end of the external sleeve, one of a part of the ancillary sleeve and a part of the intermediate sleeve penetrates the C-ring, the threaded engagement of said external thread with the internal thread serves to combine the intermediate sleeve and the ancillary sleeve, and the ancillary sleeve comes into contact with the part of the C-ring projecting more than the inner circumferential face of the external sleeve from the other end side of the external sleeve, thereby resulting in fitting the intermediate sleeve inside the external sleeve.

17. The composite holding device, as set forth in claim 6, wherein:
said casing comprises an external sleeve, an intermediate sleeve fitted inside the external sleeve with the assistance of an ancillary sleeve, and a nose rotatable in relation to the external sleeve and the intermediate sleeve;
an internal thread is formed on an inner circumferential face of the intermediate sleeve and a slit is formed on the internally threaded part of the intermediate sleeve;
an external thread is formed on an outer circumferential face of the ancillary sleeve;
one of the externally threaded part of the ancillary sleeve and the internally threaded part of the intermediate sleeve has a tapered shape; and
the internal thread of the intermediate sleeve inserted into the external sleeve engages with the external thread of said ancillary sleeve inserted into the external sleeve and the intermediate sleeve, the slit of the intermediate sleeve being expanded to press the internally threaded part against an inner circumferential face of the external sleeve to fix the intermediate sleeve to the external sleeve, thereby to fit the intermediate sleeve inside the external sleeve.

18. The composite holding device, as set forth in claim 6, wherein:
said casing comprises an external sleeve, an intermediate sleeve fitted inside the external sleeve with assistance of an ancillary sleeve and an elastic ring, and a nose rotatable in relation to the external sleeve and the intermediate sleeve;
an internal thread is formed on either one of the intermediate sleeve and the ancillary sleeve, and an external thread to engage with the internal thread is formed on the other one of the intermediate sleeve and the ancillary sleeve;
the intermediate sleeve and the elastic ring adjacent to the intermediate sleeve in the axial direction, are inserted into the external sleeve, the ancillary sleeve is inserted into the external sleeve from the elastic ring side, one of a part of the ancillary sleeve and a part of the intermediate sleeve penetrates the elastic ring, the threaded engagement of said external thread and internal thread with each other serves to combine the intermediate sleeve and the ancillary sleeve, and the elastic ring is compressed in the axial direction between the ancillary sleeve and the intermediate sleeve to be pressed against an inner circumferential face of the external sleeve, thereby to be fixed to the external sleeve, thereby resulting in the fitting of the intermediate sleeve inside the external sleeve.

19. The composite holding device, as set forth in claim 6, wherein:
said casing comprises an external sleeve, an intermediate sleeve fitted inside the external sleeve with the assistance of an ancillary sleeve and a C-ring, and a nose rotatable in relation to the external sleeve and the intermediate sleeve;
an annular concave part is formed on an inner circumferential face of the external sleeve, and the C-ring is fitted into the annular concave part to project more in a direction of the internal diameter than the inner circumferential face of the external sleeve;
an internal thread is formed on either one of the intermediate sleeve and the ancillary sleeve, and an external thread to engage with the internal thread is formed on the other one of the intermediate sleeve and the ancillary sleeve;
a part of the intermediate sleeve is inserted into the external sleeve from one end of the external sleeve, and the other part of the intermediate sleeve not inserted into the external sleeve is brought into contact with the one end of the external sleeve; and
the ancillary sleeve is inserted into the external sleeve from the other end of the external sleeve, one of a part of the ancillary sleeve and a part of the intermediate sleeve penetrates the C-ring, the threaded engagement of said external thread with internal thread serves to combine the intermediate sleeve and the ancillary sleeve, and the ancillary sleeve comes into contact with the part of the C-ring projecting more than the inner circumferential face of the external sleeve from the other end side of the external sleeve, thereby resulting in the fitting of the intermediate sleeve inside the external sleeve.

20. A holding device, comprising:
a casing for accommodating a plurality of holders for holding media;
a supporting section for supporting said holders to be movable;
means for selectively advancing one of the plurality of holders; and
means for operating the advancing means, to project the tip of one of the plurality of holders out of a fore end opening at the tip of the casing and make usable the tip of one of the plurality of holders,
wherein a supported section of each holder supported by said supporting section is rotatably supported in relation to the supporting section.
